(19) United States
(12) Patent Application Publication
(10) Pub. No.: US 2011/0139141 A1
(43) Pub. Date: Jun. 16, 2011

(54) CLEANABILITY OF OVENS AND COOKTOPS

(76) Inventors: Timothy Scott Shaffer, Louisville, KY (US); Donald Joseph Breit, Louisville, KY (US); John Mark Smith, Louisville, KY (US); Brian M. Steurer, Louisville, KY (US); Daniel Joseph Trice, Louisville, KY (US)

(21) Appl. No.: 12/639,138

(22) Filed: Dec. 16, 2009

(51) Int. Cl. A21B 1/00; B05D 3/12; B05D 3/10

(52) U.S. Cl. 126/273 R; 427/299; 427/307

(57) ABSTRACT

An oven cavity for an oven or range appliance includes a heat-stable base substrate, and a hard ceramic coating disposed on the base substrate. The hard ceramic coating is a poly-condensated silicone, polymeric silazane or poly-ceramic coating composition. A method of forming a surface for an oven or range appliance is also disclosed.

### BACKGROUND OF THE INVENTION

The embodiments of the present invention generally relate to a cooking surface for an oven or range appliance. More particularly, the exemplary embodiments relate to a coating for a surface of an oven or range appliance.

Oven cavities are traditionally coated with a hard, porcelain enamel coating. While extremely hard and durable, food residue tends to stick to this porcelain enamel coating, and elaborate means must be employed to clean and remove such food residue. Many residential ovens include a “self-cleaning” function, or high temperature cleaning cycle. The high temperature cleaning cycle temporarily raises temperatures in the oven to a level that is high enough to promote pyrolysis of the food residue on the surfaces of the oven cavity. While this process is effective, it is wasteful of energy, and adds material and manufacturing cost to the oven appliance to accommodate the high temperatures that must be achieved.

Cooktops are also traditionally coated with a hard, porcelainized enamel coating of similar properties to the oven coating. Foods and food byproducts are often times spilled upon the cooking surface and baked into a hard varnish-like residue that clinges strongly to the enamel coating. Unlike the oven, the cooktop can not conveniently be self-cleaned. Often times, the consumer must apply any one of a variety of methods to clean the cooktop. These can include for example, harsh chemicals, large amounts of force or the use of harsh cleaning pads that can damage the cooktop coating.

It would be advantageous to provide a hard durable coating for a cooktop that resists baked on food stains better than the enamel coating currently used.

Certain soft coatings (<6H pencil hardness) such as fluoropolymers (Teflon, Excalibur, etc.) have been proposed that have desirable release properties. However, these soft coatings may neither have the required durability, surface hardness, nor the ability to survive in the high temperature environment of cooking appliances.

Considerable effort has been directed at producing an effective, non-stick and non-wetting coating on a substrate that constitutes the surface of cookware for preparing food. The term “non-stick” signifies a surface that resists the adherence of substances, such as oils, greases, or other food items. The “non-stick” property permits easy cleaning of dishes in which foods are prepared by heating. The term “non-wetting” indicates a surface that repels liquids such as water. The “non-wetting” property is evidenced by a large contact angle between a drop of liquid (water, oil, etc.) and the surface on which the drop rests. An advancing angle of at least 90 degrees is considered as representative of a non-wettable surface. While this has been successfully demonstrated on dishes and cookware, it is more problematic with large enclosed structures such as oven cavities or cooking appliances.

Accordingly, it would be desirable to provide a hardened non-stick surface for an oven or range appliance that addresses at least some of the problems identified above.

### BRIEF DESCRIPTION OF THE INVENTION

As described herein, the exemplary embodiments overcome one or more of the above or other disadvantages known in the art.

One aspect of the exemplary embodiments relates to an oven cavity for an oven or range appliance. In one embodiment, the oven cavity includes a heat-stable base substrate, and a hard ceramic coating disposed on the base substrate. The hard ceramic coating includes a poly-condensated silicone, a polymeric silazane or a poly-ceramic coating composition.

Another aspect of the exemplary embodiments relates to a method of forming a surface for an oven or range appliance. In one embodiment, the method includes preparing a base substrate of the oven or range appliance by roughening the base substrate, and applying a hard ceramic coating to the prepared base substrate, wherein the hard ceramic coating includes a poly-condensated silicone, a polymeric silazane or a poly-ceramic coating composition.

These and other aspects and advantages of the exemplary embodiments will become apparent from the following detailed description considered in conjunction with the accompanying drawings. It is to be understood, however, that the drawings are designed solely for purposes of illustration and not as a definition of the limits of the invention, for which reference should be made to the appended claims. Moreover, the drawings are not necessarily drawn to scale and that, unless otherwise indicated, they are merely intended to conceptually illustrate the structures and procedures described herein. In addition, any suitable size, shape or type of elements or materials could be used.

### BRIEF DESCRIPTION OF THE DRAWINGS

In the drawings:

FIGS. 1 and 2 are a schematic illustrations of an exemplary appliance incorporating features of an exemplary embodiment.

### DETAILED DESCRIPTION OF THE EXEMPLARY EMBODIMENTS OF THE INVENTION

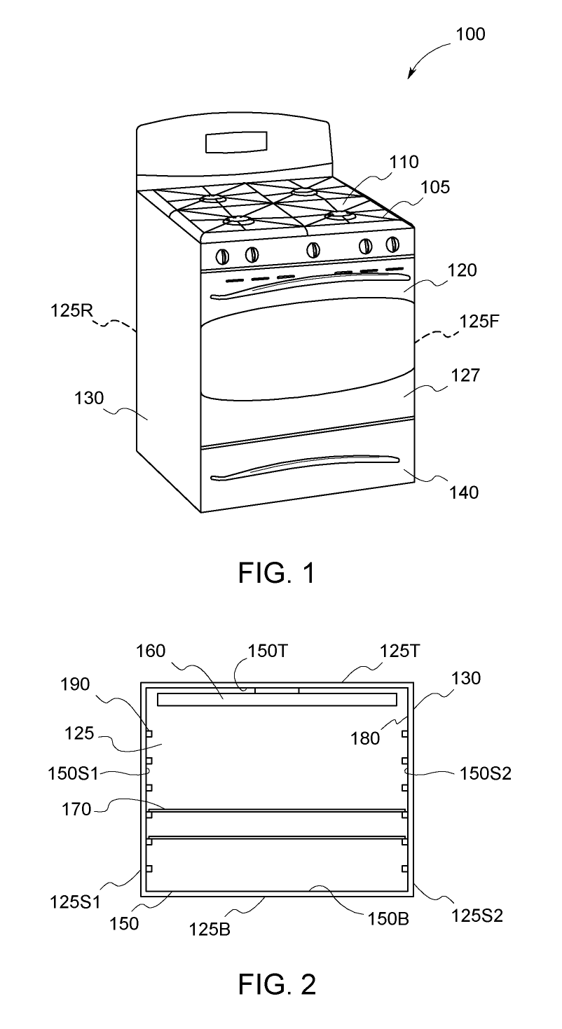

In one exemplary embodiment, referring to FIG. 1, a cooking appliance 100 is provided. The aspects of the disclosed embodiments are generally directed to preparing and forming a surface for complex cooking appliance surfaces such as oven cavities, door liners, front frames and even cooktops. Although the embodiments disclosed will be described with reference to the drawings, it should be understood that the embodiments disclosed can be embodied in many alternate forms. In addition, any suitable size, shape or type of elements or materials could be used. In the examples described herein, the cooking appliance 100 is configured as a free standing range. However, it should be understood that the aspects of the exemplary embodiments may be applied to any suitable oven or range appliance having any suitable cooking surface and/or oven cavity in a manner substantially similar to that described herein.

As shown in FIG. 1, the cooking appliance 100 includes a cooktop 110 and an oven 120. In the example shown in FIG. 1, the cooking appliance also includes a warming drawer/mini-oven 140. The cooking appliance 100 of FIG. 1 is in the form of an electrically powered, free standing range. In alternate embodiments, the cooking appliance 100 may be any suitable cooking appliance, including but not limited to combination induction/electric and gas/electric cooking appliances.

The cooking appliance 100 includes a frame or housing 130. The frame 130 forms a support for the cooktop 110 as well as internal cavities, such as the oven cavity 125 of the oven 120 and the warming drawer/mini-oven 140. In one embodiment, a separate cavity can be provided for the mini-oven 140, other than including oven cavity 125. The oven cavity 125 includes a heating source, which, in this example, is an electric heater 160 is disposed within the oven cavity 125. Alternatively, a gas burner could be used as the heating source for cooking and self-cleaning. The cooktop 110 includes one or more cooking grates 105 for supporting cooking utensils on the cooktop 110.

Referring also to FIG. 2, the oven cavity 125 is defined by a top side 125T, a bottom side 125B, a front side 125F, a rear side 125R, and lateral sides 125S1, 125S2. The oven cavity 125 may have any suitable dimensions and includes one or more rack supports 190. The rack supports 190 may be located at spaced apart positions for holding one or more oven racks 170 in place, so that food items may be placed on the oven rack(s) 170 for cooking.

In one embodiment, an oven cavity liner 150 defines the interior surfaces of the oven cavity 125. The oven cavity liner 150 has a top wall 150T, bottom wall 150B, rear wall 150R, and lateral walls 150S1, 150S2. The door 127 to the oven cavity 125 will also form the front wall portion of the oven cavity liner 150. The oven cavity liner 150 is generally formed from a carbon steel material. In alternate embodiments, the oven cavity liner 150 and other cooking surfaces can include any suitable material or substrate that is heat-stable.

In accordance with the aspects of the disclosed embodiments, a coating 180 is applied to at least the interior surfaces of the oven cavity 125, such as the oven cavity liner 150. In alternate embodiments, the coating 180 can be applied to other components and surfaces surrounding the oven cavity 125, particularly those areas that are prone to the accumulation of food residue or other by-products of cooking. The coating 180 is hard, durable and resistant to stains and food sticking. The release properties of the coating 180 advantageously improve standard oven cleaning performance, without the need to expose the surfaces of oven cavity 125, and surrounding components, to the high temperatures normally required during self-cleaning cycles. In the case of steam cleaning, which tends to be limited in removing oil base stains and food residue, the non-stick characteristics of the coating 180 advantageously compliment the steam cleaning action by making it easier to remove oil base stains and food residues. An oven cavity 125 coated with the coating 180 offers a low energy cleanup.

The coating 180 is a hard ceramic coating that is heat stable, durable and its composition and structure does not deteriorate when exposed to high temperatures. One coating that has been developed is a non-stick ceramic (poly-condensated silicone) coating using an inorganic network of metal alkoxides and an organic network of polysilanes and then applying them via a sol-gel process. This type of coating is typically applied in two layers, where the base or first layer is typically a combination of polydimethylsiloxane in a matrix of mixed materials including organoalkoxysilane, silica sol and alcoholic solvent. The second layer is usually applied to further enhance the non-stick properties and change color by including fluoroalkoxysilanes along with polydimethylsiloxane and the matrix of mixed materials listed above. Such coatings are commercially available from Thermolon, Ltd under the trademark Thermolon™ and come in numerous varieties depending on the combination of polydimethylsiloxane, flouoalkoxysilanes, and the matrix materials. The non-stick behavior of Thermolon™ coatings as well as many of the poly-condensated silicone finishes can generally withstand temperatures up to 750 degrees Farenheit indefinitely without any serious loss of performance. However, it takes considerable surface preparation to get the non-stick coating to adhere to substrates made of carbon steel and aluminum. Also oxidation protection can be a problem, when coating a geometrically complex surface that does not always permit complete surface preparation for the coating.

Another such coating is a polyceramic coating containing both polymeric and ceramic components to enable hard, durable surfaces with excellent release properties. A common tradename for one such product is Cerakote™, sold by NIC, where the polyceramic materials is mixed into a solvent and then applied as a sol-gel via spraying, brushing or wiping. Another such product is sold under the Ceraset™ trade name by KiON International. While this type of coating is commonly used on products such as gun barrels, which also desire good release properties, these products like the cookware listed for the first coating are easily sandblasted offline to properly prepare the substrate prior to coating. Without this surface or substrate preparation, the coating will not reliably adhere to the substrate.

In one embodiment, the coating 180 generally is comprised of a poly-condensated silicone or a polymeric silazane finish (commonly called Thermolon™) or a poly-ceramic finish (commonly branded under Ceraset™ and Cerakote™ brands). In alternate embodiments, the coating 180 can include any suitable heat stable coating that is uncommonly hard, provides outstanding release properties and will adhere to the pre-treated surfaces of an oven cavity as described herein.

Typically, the oven cavity 125 will be formed from a carbon steel material to which a porcelain enamel finish can be applied. In order for the coating 180 of the disclosed embodiments to adhere to the surfaces of the oven cavity 125, a pre-treatment or pre-roughing preparation process is required to roughen the surface of the base substrate. The roughening of the surface of the base substrate will enable the mechanical coupling of the coating 180 to the base substrate. When the base substrate is a carbon steel material, the coating 180 can be applied directly to the roughended carbon steel material. When the base substrate includes a porcelain enamel finish, no pre-roughing prepartion is needed for the base substrate and the coating 180 can be applied directly to the porcelain enamel finish. In one embodiment, a coating 180 including a polymeric silazane finish has been demonstrated to be effective when applied directly over the porcelain enamel finish. Although the oven cavity 125 is described herein with respect to a carbon steel material and porcelain enamel finish, the coating 180 can be used in conjunction with an oven cavity 125 including any suitable material and finish.

In one embodiment, the pre-treatment or pre-roughening preparation process generally includes roughening the surface of the base substrate of the oven cavity 125 using a mechanical or chemical process. Although sandblasting is a surface preparation process commonly used with cookware, it is not generally practical with respect to oven cavity surfaces. In one embodiment, a steel plate is pre-roughened prior to forming and bending the steel plate into its final shape. For example, pre-roughened coils or blanks can be used, where the surface roughness is typically greater than 125 RA. The pre-roughened coils or blanks are either rolled or coined into steel at a mill, or the blank is sandblasted prior to being formed into the final oven shape. As an example, the substrate is pre-treated at the steel mill or a secondary supplier by a roll or brush that mimics the required surface roughness characteristic for providing adequate adherence. The components are then formed into the final shape, where the drawn zones still maintain their rough surface.

In another embodiment, a boundary layer, also referred to as a bond coating or intermittent coating, is applied over the base substrate. In this approach, the base substrate needs not to be pre-roughened. The bond coating readily adheres to the substrate material and provides a sufficiently roughened top surface to which the coating 180 can mechanically attach when it is applied. In one embodiment, the bond coating is comprised of a magnesium oxide or phosphorus coating, which readily attaches to a base substrate such as the carbon steel material. A porcelain enamel coating could be applied to the base substrate before the bond coating is applied.

The exemplary embodiments described herein provide for applying a hard ceramic coating to the pre-treated or roughened surfaces of oven and range appliances, such as oven cavities and cooktops. The coating of the disclosed embodiments is uncommonly hard and provides outstanding release properties, making the treated substrate resistant to stain and food sticking. The coating makes the substrate easier to clean, without the need to expose the substrate to high temperatures, as in an oven self-clean cycle. The coupling of this coating with an oven cavity and/or cooktop surface advantageously permits the easy transition from a oven industry dominated by self clean functions to a industry dominated by easy cleanup and lower temperature, lower cost oven designs.

Thus, while there have been shown and described and pointed out fundamental novel features of the invention as applied to the exemplary embodiments thereof, it will be understood that various omissions and substitutions and changes in the form and details of devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. An oven cavity for an oven or range appliance, comprising:
a heat-stable base substrate; and
a hard ceramic coating disposed on the base substrate, wherein the hard ceramic coating comprises a poly-condensated silicone, a polymeric silazane or a poly-ceramic coating composition.

2. The oven cavity of claim 1, wherein the base substrate comprises a roughened surface with a surface roughness of greater than 125 RA, the hard ceramic coating being disposed on the roughened surface.

3. The oven cavity of claim 2, wherein the base substrate comprises a carbon steel material.

4. The oven cavity of claim 1, wherein the base substrate comprises a carbon steel material with a porcelain enamel coating, the hard ceramic coating being disposed on the porcelain enamel coating.

5. The oven cavity of claim 1, further comprising a bond coating disposed on the base substrate, the hard ceramic coating being disposed over the bond coating.

6. The oven cavity of claim 5, wherein the bond coating forms a roughened surface that allows the hard ceramic coating to mechanically attach to the bond coating.

7. The oven cavity of claim 5, wherein the bond coating is a phosphorous coating or a magnesium oxide coating.

8. The oven cavity of claim 1, wherein the base substrate comprises a porcelain enamel coating and the hard ceramic coating is applied to the porcelain enamel coating.

9. A method of forming a surface for an oven or range appliance, comprising:
preparing a base substrate of the oven or range appliance by roughening a surface of the base substrate; and
applying a hard ceramic coating to the roughened surface of the base substrate, wherein the hard ceramic coating comprises a poly-condensated silicone, a polymeric silazane or a poly-ceramic coating composition.

10. The method of claim 9, wherein the base substrate comprises a carbon steel material.

11. The method of claim 9, wherein the base substrate comprises a porcelain enamel coating.

12. The method of claim 9, wherein the roughened surface is obtained prior to forming the base substrate into a final shape.

13. The method of claim 9, wherein the roughening comprises a mechanical or chemical roughening process, and the roughened surface has a surface roughness of greater than 125 RA.

14. The method of claim 9, wherein the roughening comprises rolling or brushing the base substrate prior to forming the base substrate into a final shape.

15. The method of claim 9, wherein the roughening comprises applying a bond coating to the base substrate, the bond coat providing the roughened surface over which the hard ceramic coating is applied.

16. The method of claim 15, wherein the bond coating comprises a phosphorous coating or a magnesium coating.

17. The method of claim 9, wherein the oven or range appliance is an oven and the surface comprises a surface of an oven cavity of the oven.

18. The method of claim 9, wherein the oven or range appliance is a range appliance and the surface comprises a cooktop of the range appliance.
